(19) United States
(12) Patent Application Publication
(10) Pub. No.: US 2003/0051586 A1
(43) Pub. Date: Mar. 20, 2003

(54) Flatwire cut-to-service method and apparatus

(76) Inventors: Hong Zhou, Plymouth, MI (US); Richard Keith McMillan II, Dearborn, MI (US)

Correspondence Address: Steven L. Oberholtzer, BRINKS HOFER GILSON & LIONE, P.O. Box 10395, Chicago, IL, 60610, US

(21) Appl. No.: 09/956,631

(22) Filed: Sep. 20, 2001

(51) Int. Cl. B26D 1/06

(52) U.S. Cl. 83/13; 83/614; 83/821

(57) ABSTRACT

A method for repairing a flatwire conductor is disclosed. The method includes aligning a cutting tool along the flatwire conductor at a first cut zone, cutting the flatwire along a transverse axis of the flatwire within the first cut zone, removing the cutting tool from the flatwire, aligning the cutting tool along the flatwire at a second cut zone, cutting the flatwire within the second cut zone, and removing the cutting tool and flatwire attached thereto to allow for replacement of the flatwire.

### FIELD OF INVENTION

The present invention relates to flatwire connections and devices and methods for repairing damages flatwire cables and associated connectors.

### BACKGROUND ART

In an ongoing effort to reduce cost and approve reliability in vehicle electrical and electronic systems, flatwire conductors having non-separable connections have gained wide spread use. One significant drawback in using non-separable connections in flatwire is the difficulty in servicing and repairing the flatwire.

One prior art service method is to cut the flatwire, remove the defective/damaged portion, and attach a service part having a service connectors therein. Unfortunately, while this prior art method achieves its intended purpose, problems still exist. For example, current prior art methods typically dictate use of a service part which is different from the originally manufactured part adding additional design effort, manufacturing complexity, and cost. Moreover, current service methods are difficult to employ correctly within the tight confines of the vehicle structure. Consequently, additional damage to the vehicle system frequently occurs.

Therefore, there exists a need for a new and improved service method and system for cutting flatwire and removing the damaged portions. The new and improved method should dispense with unique service parts and facilitate remanufacturing of the defective/damaged part as well as reuse of the service tool.

### SUMMARY OF THE INVENTION

In accordance with an aspect of the present invention, a method and apparatus for replacing flatwire in electrical systems is provided. The flatwire of the present invention includes design features to facilitate the method and apparatus used to repair the damaged or defective segment of the flatwire. For example, a cut-to-service area is provided in the flatwire having features to facilitate engagement and alignment of a cutting tool. The flatwire also includes two service connector attachment areas on opposing sides of the cut-to-service area. The service connector attachment areas allow a defective or damaged segment of the flatwire to be remanufactured and reused as a service part. Further, the service area design is symmetrical so that the flatwire segment on either side of the cut-to-service area may be removed if defective or damaged using an identical cutting tool and replaced with a replacement flatwire segment.

In accordance with another aspect of the present invention, the service are of the flatwire allows replacement segments to be fabricated by cutting original equipment segments and attaching the service connectors at the service connector attachment areas.

In accordance with another aspect of the present invention, a damaged or defective flatwire segment which has been removed and repaired is used as a replacement segment by attachment of a service connector.

In another aspect of the present invention, a cutting tool is provided having features for engaging and aligning with the flatwire cut-to-service area to ensure that cutting occurs at the correct location and orientation.

In yet another aspect of the present invention, a cutting tool is provided with a clamp for retaining a defective or damaged flatwire segment on the cutting tool during and after cutting.

In yet another aspect of the present invention, a cutting tool having a symmetrical design for cutting defective or damaged flatwire segments on either side of a cut-to-service area using the same cutting tool is provided.

In yet another aspect of the present invention, the cutting tool is provided with a cutting member and an indicator mark showing the segment of the flatwire to be removed.

In still another aspect of the present invention, a service kit is provided having a cutting tool and a replacement flatwire segment wherein the flatwire segment has a service connector attached at a service connector attachment area.

In still another aspect of the present invention, a method for servicing a flatwire electrical system is provided. The method includes identifying the defective or damaged flatwire segment, aligning the cutting tool at the cut-to-service area with the indicator mark pointing toward the flatwire segment to be removed, engaging the cutting tool clamp, actuating the cutting mechanism, removing the cutting tool and defective segment, and returning the cutting tool and defective segment to a remanufacturing center for repair or reuse.

In yet another aspect of the present invention, a remanufacturing process is provided for processing the defective or damaged flatwire segments. The remanufacturing process includes receiving the defective or damaged flatwire segment having the cutting tool clamped thereon, removing the cutting tool, identifying the flatwire segment which is damaged or defective and repairing it, if possible, attaching a service connector to the repaired flatwire segment at the service connector location, and assembling a service kit using the returned cutting tool and remanufactured flatwire segment.

Further aspects, features and advantages of the invention will become apparent from consideration of the following description and the appended claims when taken in connection with the accompanying drawings.

### BRIEF DESCRIPTION OF THE DRAWINGS

FIG. 1 is a top view of a flatwire segment, in accordance with the present invention;

FIGS. 2a-2b is front and side views of a cutting tool for cutting a flatwire segment, in accordance with the present invention; and

FIGS. 3a-3e are perspective views of another embodiment of a cutting tool for cutting flatwire, in accordance with the present invention.

### DETAILED DESCRIPTION OF THE PREFERRED EMBODIMENT

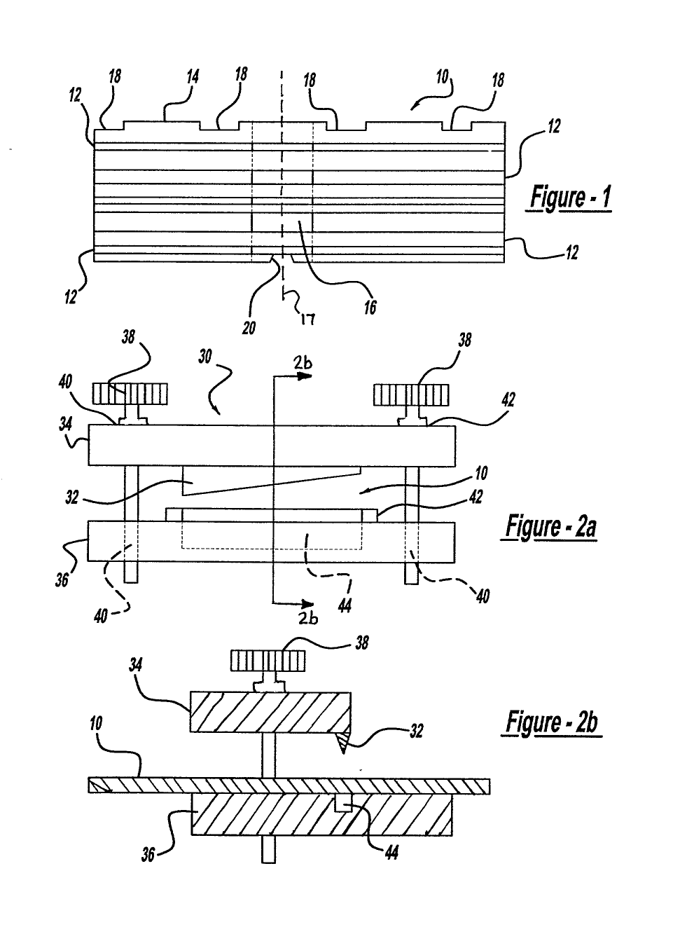

Reference is now made to FIG. 1 wherein a flatwire electrical conduit 10 is illustrated, in accordance with the present invention. Flatwire 10 includes a plurality of conductors 12 for transmitting electrical signals to various parts of an electronic system. Typically, flatwire 10 is constructed with copper as the conductors 12. The copper conductors are disposed on a flexible substrate such as MYLAR or similar material. MYLAR is available through Dupont Corporation of Delaware. MYLAR is a Dupont trade name for PET.

In a preferred embodiment of the present invention a system and method is provided for servicing flatwire 10. Typically, when flatwire 10 is damaged or is otherwise inoperable, portions of the flatwire 10 must be removed, and operable flatwire 10 portions must be inserted in place thereof. In accordance with an embodiment of the present invention, flatwire 10 includes a reconnect area 16 wherein conductors 12 are exposed. Reconnect area 16 is disposed along the flatwire 10 at desired intervals which may be regular or irregular intervals. Thus, when damage occurs in the flatwire 10 the portion of wire between the reconnect areas may be removed and a new or remanufactured operable portion of flatwire may be inserted in place thereof.

In an embodiment of the present invention, features are present in flatwire 10 to facilitate cutting and replacement of an inoperable portion of the flatwire. Such features may include an alignment feature 18 and a cut starting notch 20. The specific operation and use of alignment feature 18 and notch 20 will be described hereinafter with reference to a cutting tool 30 which is provided in another embodiment of the present invention.

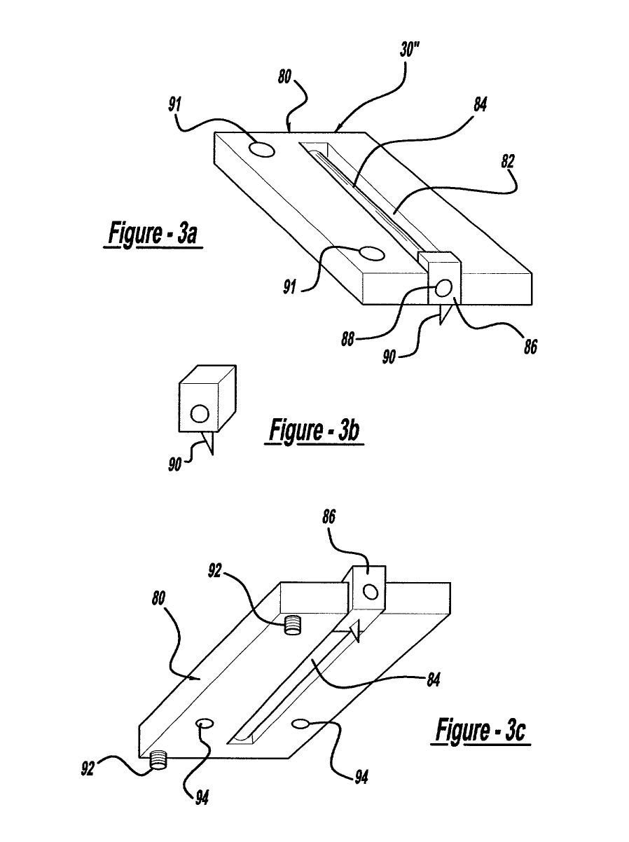

Referring now to FIG. 2a, an embodiment of the cutting tool 30 is illustrated, in accordance with the present invention. FIG. 2a is a front view of cutting tool 30 illustrating a blade 32 fixedly mounted to a upper clamp member 34 for shearing and cutting flatwire 10. Upper clamp portion 34 is directed towards a lower clamp portion 36 by pair of screws 38 which are received in cooperating threaded apertures 40.

Lower clamp portion 36 includes an alignment fixture 42 which is cooperatively configured to receive alignment feature 18 thereby ensuring the flatwire 10 and a cutting blade 32 is aligned within the reconnect area 16. As will be seen in subsequent figures, lower clamp member 36 further includes a blade groove 44 for receiving the cutting blade 32. Blade groove 44 has a depth sufficient to ensure that when the blade is lowered into and beyond flatwire 10 the edge of the blade does not crash into the bottom of the blade groove 34.

A cross-sectional view, at a location indicated in FIG. 2a, of the flatwire 10 disposed within cutting tool 30 is illustrated in FIG. 2b, in accordance with the present invention. In operation, flatwire 10 is positioned between upper clamp member 34 and lower clamp member 36 and alignment features 18 cooperate with alignment fixture 42 to ensure blade 32 is properly aligned with flatwire 10 and within the reconnect area 16 along a cut line 17. An operator turns screws 38 forcing the upper clamp member 34 toward lower clamp member 36 and eventually causing cutting blade 36 to shear flatwire 10 along the cut line 17. In an embodiment of the present invention the cutting tool 30 is placed on the inoperable or damaged portion of the flatwire 10. Upon shearing of the flatwire 10, the cutting tool 30 and the inoperable portion of flatwire 10 may be shipped to a facility for remanufacturing of replacement parts, such as replacement flatwire portions. Thus, the present invention provides a system and method for reusing the cutting tool and remanufacturing and/or refurbishing inoperable portions of the flatwire 10.

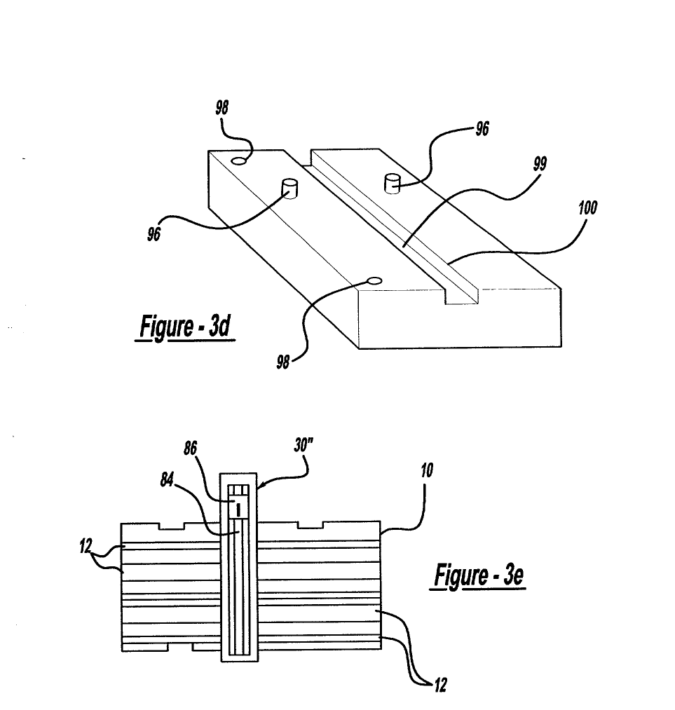

Referring now to FIG. 3a through FIG. 3e, an alternative embodiment of cutting tool 30 is illustrated, in accordance with the present invention. Alternative cutting tool 30″ includes a top plate 80 shown in FIG. 3a, and a bottom plate 100 shown in FIG. 3d. Top plate 80 has a longitudinal slot 82 for receiving a guide pin 84. Guide pin 84 is fixedly secured to top plate 80 and slideably guides a cutter block 86 for movement within slot 82. Cutter block 86 includes a guide pin aperture 88 configured to receive guide pin 84 to facilitate cooperative movement of the cutter block 86 along guide pin 84. Cutter block 86 further includes a cutting blade 90 fixedly secured to a bottom surface of cutter block 86. Further, top plate 80 includes a pair of apertures 91 for receiving screws 92 (shown in FIG. 3c). Screws 92 are used to removeably attach the top plate 80 to bottom plate 100, as will become apparent hereinafter.

FIG. 3c is a bottom perspective view of top plate 80. In addition to further illustrating cutter block 86, cutting blade 90 and other features of top plate 80, such as a pair of guide apertures 94 are illustrated. Guide apertures 94 cooperate with a pair of alignment pins 96 disposed on bottom plate 100, as shown in FIG. 3d, to align the top plate 80 with bottom plate 100. Thus, the assembly of the top plate 80 onto the bottom plate 100 may be accomplished quickly and easily.

With specific reference to FIG. 3d, bottom plate 100 is further illustrated, in accordance with the present invention. A pair of threaded apertures 98 receive screws 92 for removeably securing top plate 80 to bottom plate 100. A groove 99 is disposed longitudinally in bottom plate 100 for providing clearance for cutting blade 90.

In operation, alternative cutting tool 30″ is secured to flatwire 10, as shown in FIG. 3e. By aligning the top plate 80 over the bottom plate 100 and securing bottom plate 100 to top plate 80 using screws 92. Cutter block 86 may then be slid longitudinally along guide pin 84 to cut flatwire 10 preferably within the reconnect area 16 and along cut line 17 (shown in FIG. 1). The resulting assembly, that is the second flatwire portion and attached cutting tool 30″, may be removed and sent to a facility equipped for recycling and/or remanufacturing flatwire 10. A flatwire connector (not shown), as well known in the art, may be attached to the remaining flatwire at the reconnect area 16. The flatwire connector may have a replacement flatwire portion, having a length equal to the flatwire portion that was removed.

The present invention has many benefits and advantages over the prior art. For example, embodiments of the present invention provide a system and method for easily replacing damaged portions of a flatwire. Moreover, the present invention provides a system and method for recycling flatwire and flatwire cutting tools.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. A method for repairing a flatwire conductor, the method comprising:
aligning a cutting tool along the flatwire conductor at a first cut zone;
cutting the flatwire along a transverse axis of the flatwire within the first cut zone;
removing the cutting tool and flatwire attached thereto to allow for replacement of the flatwire.

2. The method of claim 1 wherein aligning the cutting tool further includes locating the flatwire on the cutting tool using an alignment feature.

3. The method of claim 1 wherein cutting the flatwire further comprises initiating cutting of the flatwire using a initiation notch.

4. The method of claim 1 further comprising clamping the cutting tool to the flatwire before cutting the flatwire.

5. The method of claim 1 wherein cutting the flatwire further includes lowering a cutting blade onto the flatwire to cut the flatwire using a shearing action.

6. The method of claim 1 wherein cutting the flatwire further includes sliding a cutting blade across the flatwire to cut the flatwire.

7. A device for cutting a flatwire having a plurality of flat electrical conductors, the device comprising:
a base for supporting the flatwire; and
a cutting member having a blade for cutting the flatwire at a desired location, wherein the cutting member is positioned above the base, and
wherein the cutting member is clamped to the base to position the blade adjacent the flatwire.

8. The device of claim 7 further comprising a clamping member for securing the cutting member to the base member.

9. The device of claim 8 wherein the clamping member is a screw.

10. The device of claim 7 wherein the base member further comprises a longitudinal slot for providing clearance for the blade.

11. The device of claim 7 wherein the base member further comprises an alignment feature for locating the flatwire on the base member.

12. A device for cutting a flatwire having a plurality of flat electrical conductors, the device comprising:
a base for supporting the flatwire;
a blade support member removably attached to the base;
a guide pin fixedly secured to the blade support member; and
a cutting member in slidable engagement with the guide pin, the cutting member having a blade for cutting the flatwire at a desired location.

13. The device of claim 12 further comprising a clamping member for securing the cutting member to the base member.

14. The device of claim 13 wherein the clamping member is a screw.

15. The device of claim 12 wherein the base member further comprises a longitudinal slot for providing clearance for the blade.

16. The device of claim 12 wherein the base member further comprises an alignment feature for locating the flatwire on the base member.
